(19) United States
(12) Patent Application Publication
(10) Pub. No.: US 2024/0405698 A1
(43) Pub. Date: Dec. 5, 2024

(54) METHOD FOR DC-BUS CAPACITANCE MINIMIZATION OF HYBRID CLAMPED CONVERTER

(71) Applicant: CHONGQING UNIVERSITY, Chongqing (CN)

(72) Inventors: Jianyu PAN, Chongqing (CN); Xiaojie FU, Chongqing (CN); Yihui ZHAO, Chongqing (CN)

(73) Assignee: CHONGQING UNIVERSITY, Chongqing (CN)

(21) Appl. No.: 18/663,133

(22) Filed: May 14, 2024

(30) Foreign Application Priority Data
May 29, 2023 (CN) 2023106156277

(51) Int. Cl. H02M 7/5387; H02M 1/00

(52) U.S. Cl. CPC H02M 7/53871; H02M 1/0009

(57) ABSTRACT

The present invention provides a method for DC-bus capacitance minimization of hybrid clamped converter (HCC), which includes: obtaining the system parameters of the HCC during operation; determining the reference wave; determining the duty ratio of each switch according to the reference wave; determining the total neutral point current of the system; the fundamental component of the upper and lower DC-bus capacitor voltage of the system; determining the maximum voltage fluctuation of the upper and lower DC-bus capacitors; determining the minimum DC-bus capacitance value that satisfies the requirements of system capacitor voltage fluctuation by traversing the capacitance value. The present invention not only reduces the design complexity and cost of the high-power HCC system, but also improves the power density and reliability of the converter.

### TECHNICAL FIELD

The present invention relates to the field of power electronics technology, specifically to a method for DC-bus capacitance minimization of hybrid clamped converter (HCC).

### BACKGROUND ART

Multilevel converter has been widely used in the industrial field, which has the advantages of smaller dv/dt, better harmonic performance, higher voltage levels, and higher power levels. However, the internal capacitor of the multilevel converter will be charged and discharged during the operation of the system, which will cause a certain voltage fluctuation in the capacitor. The problem of high voltage fluctuation on the capacitor of a multilevel converter under low-frequency conditions is usually solved by increasing the capacitance of the capacitor. However, for high-voltage capacitors, the volume and cost will increase significantly as the capacitance increases. Consequently, this will inevitably increase the system cost, reduce the system power density, and make the multilevel converter unable to meet the requirements of practical applications.

For the emerging medium and high voltage multilevel converter HCC, due to the existence of three DC-bus capacitors and three flying capacitors, it also has a complex capacitance minimization problem. When the DC-bus capacitor voltage fluctuation of HCC is effectively controlled, there is a complex relationship between the DC-bus capacitor voltage fluctuation, capacitor size, and system parameters of HCC. In recent years, much research has been carried out to solve many challenging problems such as HCC model construction, voltage balance control, integrated control, and soft start method. However, there are few studies on the DC-bus capacitance minimization problem of HCC, the lack of DC-bus capacitance minimization methods makes the design and parameter selection of DC-bus capacitors in high-power HCC systems extremely difficult.

Therefore, how to propose an effective design method for the DC-bus capacitance minimization of HCC, and quickly and effectively determine the minimum DC-bus capacitance of the system within the allowable capacitor voltage fluctuation range of the system is of great significance to the design of high-power HCC system.

### SUMMARY

In view of this, the objective of the present invention is to provide an effective design method for DC-bus capacitance minimization of HCC. This present invention aims to solve the problem of the difficult selection of the HCC DC-bus capacitors. The DC-bus capacitance parameters for high-power HCC system can be quickly determined according to the design method for the DC-bus capacitance minimization of HCC proposed in this present invention.

To achieve the above objective, the present invention provides a design method for DC-bus capacitance minimization of HCC, including the following steps:
step 1: obtaining a DC-bus voltage V_{dc}, a reference wave frequency f_{ac}, a carrier frequency f_{c}, a modulation ratio mₐ, a power factor cos φ, a load impedance Z, and a system capacitor voltage fluctuation limit ΔVₗᵢₘᵢₜ when the HCC is operating;
step 2: determining a reference wave V′_{ref_x}:

$${V}_{{ref}_{-} x}^{′} = {V}_{{ref}_{-} x} + {V}_{com} = \{ \begin{matrix}{V}_{{ref}_{-} a} + {V}_{com} = \frac{{m}_{a}}{2} sin ( 2 π {f}_{a c} t ) + 0.5 + {V}_{c o m} \\ {V}_{{ref}_{-} b} + {V}_{com} = \frac{{m}_{a}}{2} sin ( 2 π {f}_{a c} t - \frac{2 π}{3} ) + 0.5 + {V}_{c o m} \\ {V}_{{ref}_{-} c} + {V}_{com} = \frac{{m}_{a}}{2} sin ( 2 π {f}_{a c} t - \frac{4 π}{3} ) + 0.5 + {V}_{c o m}\end{matrix}$$

where, V_{ref_x} takes V_{ref_a}, V_{ref_b}, V_{ref_c}, V_{ref_a}, V_{ref_b}, and V_{ref_c} denotes a reference wave of a-phase, b-phase, and c-phase, respectively; V_{com} denotes a common-mode voltage;
step 3: determining a switch duty ratio D_{Nx} of HCC according to the reference wave V′_{ref_x}:

$${D}_{N x} = f ( {V}_{{ref}_{-} x}^{′} ) = \{ \begin{matrix}2 {V}_{{ref}_{-} x} & 0 \leq {V}_{{ref}_{-} x}^{′} \leq 1 / 3 \\ 2 / 3 & 1 / 3 \leq {V}_{{ref}_{-} x}^{′} \leq 2 / 3 \\ 2 ( 1 - {V}_{{ref}_{-} x}^{′} ) & 2 / 3 \leq {V}_{{ref}_{-} x}^{′} \leq 1\end{matrix}$$

step 4: determining a total neutral point current i_{N} of the HCC system according to the switch duty ratio D_{Nx} and a load current iₒₓ:

$${i}_{N} = {D}_{N a} {□ i}_{o a} + {D}_{N b} {□ i}_{ob} + {D}_{Nc} {□ i}_{oc}$$

where D_{Nx} denotes a switch duty ratio of a-phase, b-phase or c-phase; D_{Na} denotes the switch duty ratio of a-phase; D_{Nb} denotes the switch duty ratio of b-phase; D_{Nc} denotes the switch duty ratio of the c-phase; iₒₓ denotes the load current of a-phase, b-phase or c-phase; iₒₐ denotes the load current of a-phase; i_{ob} denotes the load current of b-phase; i_{oc} denotes the load current of c-phase;
step 5: determining a fundamental component V_{cap} of the capacitors voltage of the upper and lower DC-bus of the system according to the total neutral point current i_{N} of the system:

$${V}_{c a p} = \frac{{\int }_{0}^{t} {i}_{N} dt}{{C}_{dl}}$$

where C_{d1} denotes a value of the DC-bus capacitance to be determined, the DC-bus capacitors are divided into three DC-bus capacitors: upper, middle, and lower, and the three capacitance values are equal.
step 6: determining a maximum voltage fluctuation ΔV_{cd1/cd3_max} of upper and lower DC-bus capacitors according to V_{cap}:

$$Δ {V}_{cd 1 / cd 3 \_max} = Δ {V}_{cd 1 / cd 3 \_f \_max} + Δ {V}_{cd 1 / cd 3 \_h \_max} = \frac{max ( {V}_{cap} ) - min ( {V}_{cap} )}{2} + 3 Δ {V}_{cd 2 \_ max}$$

where ΔV_{cd1/cd3_f_max} is the fundamental component of the maximum voltage fluctuation of the upper and lower DC-bus capacitors, ΔV_{cd1/cd3_h_max} is a harmonic component of the maximum voltage fluctuation of the upper and lower DC-bus capacitors; max(V_{cap}) is a maximum value of the fundamental component of the upper and lower DC-bus capacitors voltage, and min (V_{cap}) is a minimum value of the fundamental component of the upper and lower DC-bus capacitors voltage; ΔV_{cd2_max} is a maximum voltage fluctuation of the middle DC-bus capacitor;
step 7: traversing the capacitance value C_{d1} from 0 to Cₘₐₓ, a step length of the traversal is M₁, repeating the above-mentioned steps 1-6 to obtain the corresponding ΔV_{cd1/cd3_max} of different capacitance values, and when the ΔV_{cd1/cd3_max} is less than or equal to ΔVₗᵢₘᵢₜ for the first time, outputting the corresponding capacitance value, that is, a minimum DC-bus capacitance value satisfying the requirement of system capacitor voltage fluctuation.

Further, in step 1, the range of ΔVₗᵢₘᵢₜ is 0-100% of the rated operating value of the capacitor voltage, and the rated operating value of the capacitor voltage is ⅓ of the DC-bus voltage.

Further, in step 2,

$${V}_{com} = 0.25 \frac{{m}_{a}}{2} sin ( 23 {f}_{ac} π t ) .$$

Further, in step 4, the load current iₒₓ satisfies

$$\{ \begin{matrix}{i}_{oa} = I sin ( 2 π {f}_{ac} t - φ ) \\ {i}_{ob} = I sin ( 2 π {f}_{ac} t - φ - \frac{2 π}{3} ) \\ {i}_{ob} = I sin ( 2 π {f}_{ac} t - φ - \frac{4 π}{3} )\end{matrix} ,$$

where I denotes a maximum load current amplitude,

$$I = \frac{1}{2} \frac{{m}_{a} {V}_{dc}}{Z} .$$

Further, in step 6,

$$Δ {V}_{cd 2 \_ max} = \frac{3 \sqrt{3} - 2}{12} \frac{I {T}_{c}}{{C}_{d 1}} ,$$

where T_{c} is a reciprocal of the carrier frequency f_{c}.

Further, the maximum voltage fluctuation of the upper and lower DC-bus capacitors as the main reference for the DC-bus capacitance minimization.

Further, in step 7, Cₘₐₓ is 0.001 mF to 100 mF, and the step length M₁ is 0.0001 mF to 5 mF.

Further, the method is applicable to a wide output current frequency 1-1000 Hz condition and a wide carrier frequency 500-10000 Hz condition.

### Advantageous Effects of the Present Invention

1) The present invention provides a design method for DC-bus capacitance minimization of HCC, in which the minimum DC-bus capacitance that satisfies the voltage fluctuation demand of the HCC capacitor is obtained by direct calculation of the constructed mathematical model. It avoids the excessive large DC-bus capacitance and significantly reduces the design complexity and volume of the HCC system.

2) The present invention provides a design method for DC-bus capacitance minimization of HCC, which applies to wide frequency conditions, effectively solves the problem of selecting the minimum HCC DC-bus capacitance, which significantly reduces the design costs of a high-power HCC converter, and has application value in the fields of medium-high voltage power conversion and motor drive, etc.

Additional advantages, objects, and features of the present invention will be set forth in part in the description that follows and in part will become apparent to those having ordinary skill in the art upon examination of the following or may be learned from practice of the invention. The objectives and other advantages of the present invention will be realized and attained by the following specifications.

### BRIEF DESCRIPTION OF THE DRAWINGS

FIG. 1 is a flow chart of the design method for the DC-bus capacitance minimization of the HCC in the present invention;

FIG. 2 is a schematic diagram of a three-phase four-level HCC circuit; and

FIG. 3 is a simulation waveform diagram of each DC-bus capacitor voltage of the HCC system under the DC-bus capacitor parameters obtained by using the design method of the present invention.

### DETAILED DESCRIPTION OF THE EMBODIMENTS

To make the technical solution, advantages, and objective of the present invention clearer, the following will describe the technical scheme of the example of the present invention clearly and completely in combination with the attached diagram of the example of the present invention. Obviously, the example described is part of the example of the present invention, not the whole example. Based on the described example of the present invention, all other examples obtained by ordinary technicians in this field without the need for creative labor are within the scope of protection of this application.

The present invention will be further elaborated hereafter in conjunction with accompanying drawings and examples.

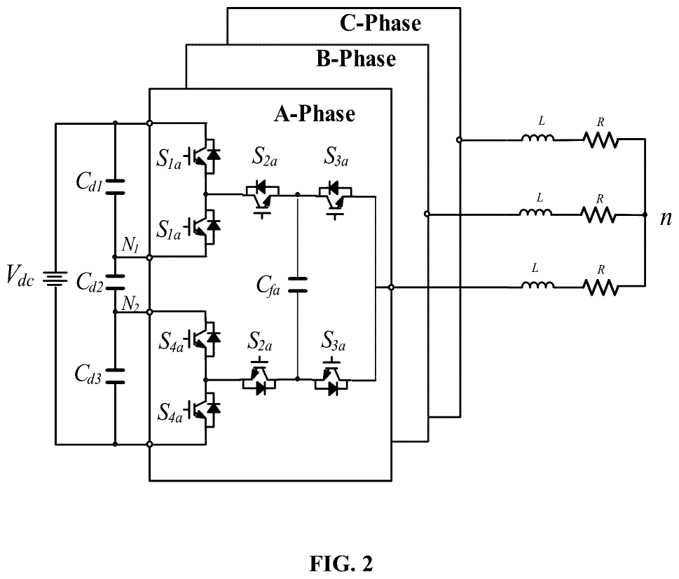

FIG. 2 is a schematic diagram of a three-phase four-level HCC circuit connection. As shown in FIG. 2, the circuit includes a DC power supply V_{dc}, a three-phase HCC, and a three-phase load Z (each phase includes a series resistance R and an inductance L). Wherein, the three-phase is a-phase, b-phase, and c-phase, respectively (also can be written as A-phase, B-phase, and C-phase).

The three-phase HCC includes three series DC-bus capacitors C_{d1}, C_{d2}, and C_{d3}, three flying capacitor C_{fa} (corresponding to a-phase), C_{fb} (corresponding to b-phase), and Cfc (corresponding to c-phase), and three bridge arms, each bridge arm contains four sets of switches. Wherein, the DC-bus capacitor C_{d1} can also be called the upper DC-bus capacitor, the DC-bus capacitor C_{d3} can also be called the lower DC-bus capacitor, and the DC-bus capacitor C_{d2} can also be called the middle DC-bus capacitor.

For any x-phase (a-phase, b-phase or c-phase), it corresponds to the flying capacitor C_{fx} and the bridge arm switches S₁ₓ and S₁ₓ′, S₂ₓ and S₂ₓ′, S₃ₓ and S₃ₓ′, S₄ₓ and S₄ₓ′. For example, as shown in FIG. 2, for a-phase, it corresponds to the flying capacitor C_{fa} and the bridge arm switches S₁ₐ and S₁ₐ′, S₂ₐ and S₂ₐ′, S₃ₐ and S₃ₐ′, S₄ₐ and S₄ₐ′. Wherein, a first end of Sla is connected to the positive electrode of the DC-bus capacitor C_{d1}, a second end of S₁ₐ is connected to a first end of S₁ₐ′ and a first end of S₂ₐ, a first end of S₁ₐ′ is also connected to the first end of S₂ₐ, a second end of S₁ₐ′ is connected to the negative electrode of the DC-bus capacitor C_{d1}, a second end of S₂ₐ is connected to a first end of S₃ₐ, a first end of S₄ₐ is connected to the positive electrode of the DC-bus capacitor C_{d3}, a second end of S₄ₐ is connected to a first end of S₂ₐ′ and a first end of S₄ₐ′, a second end of S₄ₐ′ is connected to the negative electrode of the DC-bus capacitor C_{d3}, a second end of S₂ₐ′ is connected to a first end of S₃ₐ′, a second end of S₃ₐ and a second end of S₃ₐ′ are connected to the load, the second end of S₂ₐ and the first end of S₃ₐ are connected to the positive electrode of the flying capacitor C_{fa}, and the second end of S₂ₐ′ and the first end of S₃ₐ′ are connected to the negative electrode of the flying capacitor C_{fa}.

It should be noted that only a specific connection mode of a-phase is shown in FIG. 2, and the specific connection mode of the b-phase and c-phase is not shown. For technicians in this field, according to FIG. 2 and the above description, it is easy to understand that the specific connection mode of the b-phase and c-phase is similar to that of a-phase, and will not described in detail here.

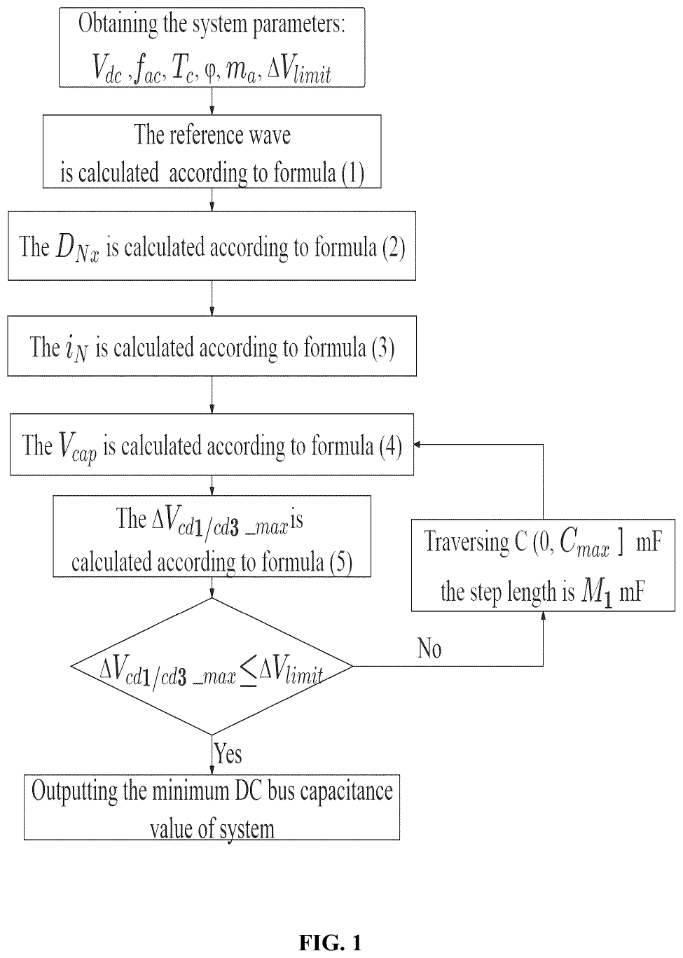

FIG. 1 is a flow chart of the design method for DC-bus capacitance minimization of HCC in the present invention. As shown in FIG. 1, including:
step 1: the DC-bus voltage V_{dc}, the reference wave frequency f_{ac}, the carrier frequency f_{c}, the modulation ratio mₐ, the power factor cos φ, the load impedance Z, and the system capacitor voltage fluctuation limit ΔVₗᵢₘᵢₜ are obtained when the HCC is operating; wherein, the capacitor voltage fluctuation limit ΔVₗᵢₘᵢₜ is the maximum DC-bus capacitor voltage fluctuation allowed by the system, the range of ΔVₗᵢₘᵢₜ is generally 0-100% of the rated operating value of the capacitor voltage, and the rated operating value of the capacitor voltage is ⅓ of the DC-bus voltage.
step 2: the reference wave V′_{ref_x} is determined according to formula (1):

$${V}_{ref\_x}^{′} = {V}_{ref\_x} + {V}_{com} = \{ \begin{matrix}{V}_{ref\_a} + {V}_{com} = \frac{{m}_{a}}{2} sin ( 2 π {f}_{ac} t ) + 0.5 + {V}_{com} \\ {V}_{ref\_b} + {V}_{com} = \frac{{m}_{a}}{2} sin ( 2 π {f}_{ac} t - \frac{2 π}{3} ) + 0.5 + {V}_{com} \\ {V}_{ref\_c} + {V}_{com} = \frac{{m}_{a}}{2} sin ( 2 π {f}_{ac} t - \frac{4 π}{3} ) + 0.5 + {V}_{com}\end{matrix} \qquad ( 1 )$$

where, V_{ref_x} takes V_{ref_a}, V_{ref_b}, V_{ref_c}, V_{ref_a}, V_{ref_b}, and V_{ref_c} denotes the reference wave of a-phase, b-phase, and c-phase, respectively; V_{com} denotes the common-mode voltage;

In some examples, V_{com} satisfies

$${V}_{com} = 0.25 \frac{{m}_{a}}{2} sin ( 23 {f}_{ac} π t ) ,$$

that is, the minimization design method is implemented on the basis of the 25% amplitude frequency tripling common-mode voltage injection control method. In other examples, the amplitude of 25% can also be any other appropriate value.
step 3: the reference wave V′_{ref_x} is substituted into formula (2) to determine the switch duty ratio D_{Nx} of HCC:

$${D}_{Nx} = f ( {V}_{ref\_x}^{′} ) = \{ \begin{matrix}2 {V}_{ref\_x}^{′} & 0 \leq {V}_{ref\_x}^{′} \leq 1 / 3 \\ 2 / 3 & 1 / 3 \leq {V}_{ref\_x}^{′} \leq 2 / 3 \\ 2 ( 1 - {V}_{ref\_x}^{′} ) & 2 / 3 \leq {V}_{ref\_x}^{′} \leq 1\end{matrix} \qquad ( 2 )$$

where the switch duty ratio D_{Nx} of HCC denotes the duty ratio of the switch (S₁ₓ⊕S₂ₓ), S₁ₓ and S₂ₓ denotes the on-off state of HCC internal switch S₁ₓ and S₂ₓ, respectively, x is a-phase, b-phase or c-phase, the switch on is 1, and the switch off is 0; ⊕ denotes an XOR operation.
step 4: the total neutral point current in of the system is determined according to the switch duty ratio D_{Nx} and the load current iₒₓ, the specific calculation method such as formula (3):

$${i}_{N} = {D}_{Na} {i}_{oa} + {D}_{Nb} {i}_{ob} + {D}_{Nc} {i}_{oc} \qquad ( 3 )$$

where D_{Nx} denotes the switch duty ratio of a-phase, b-phase or c-phase; D_{Na} denotes the switch duty ratio of a-phase; D_{Nb} denotes the switch duty ratio of b-phase; D_{Nc} denotes the switch duty ratio of the c-phase; iₒₓ denotes the load current of a-phase, b-phase or c-phase; iₒₐ denotes the load current of a-phase; i_{ob} denotes the load current of b-phase; i_{oc} denotes the load current of c-phase;
in some examples, the load current lox satisfies the following formula:

$$\{ \begin{matrix}{i}_{oa} = I sin ( 2 π {f}_{ac} t - φ ) \\ {i}_{ob} = I sin ( 2 π {f}_{ac} t - φ - \frac{2 π}{3} ) \\ {i}_{ob} = I sin ( 2 π {f}_{ac} t - φ - \frac{4 π}{3} )\end{matrix} ,$$

where the maximum load current amplitude I satisfies

$$I = \frac{1}{2} \frac{{m}_{a} {V}_{dc}}{Z} .$$

Step 5: the fundamental component V_{cap} of the capacitor voltages of the upper and lower DC-bus of the system is determined according to the total neutral point current in of the system, the specific calculation method such as formula (4):

$${V}_{cap} = \frac{{\int }_{0}^{t} {i}_{N} dt}{{C}_{d 1}} \qquad ( 4 )$$

where C_{d1} denotes a value of the DC-bus capacitance to be determined, where the DC-bus capacitors is divided into three DC-bus capacitors: upper, middle, and lower, and the three capacitance values are equal.

Step 6: the maximum voltage fluctuation ΔV_{cd1/cd3_max} of upper and lower DC-bus capacitors is determined according to V_{cap}, the specific calculation method such as formula (5):

$$Δ {V}_{cd 1 / cd 3 \_ max} = Δ {V}_{cd 1 / cd 3 \_ f \_ max} + Δ {V}_{cd 1 / cd 3 \_ h \_ max} = \frac{max ( {V}_{cap} ) - min ( {V}_{cap} )}{2} + 3 Δ {V}_{cd 2 \_ max} \qquad ( 5 )$$

where ΔV_{cd1/cd3_f_max} is the fundamental component of the maximum voltage fluctuation of the upper and lower DC-bus capacitors; ΔV_{cd1/cd3_h_max} is the harmonic component of the maximum voltage fluctuation of the upper and lower DC-bus capacitors; max(V_{cap}) is the maximum value of the fundamental component of the upper and lower DC-bus capacitors voltage, and min(V_{cap}) is the minimum value of the fundamental component of the upper and lower DC-bus capacitors voltage; ΔV_{cd2_max} is the maximum voltage fluctuation of the middle DC-bus capacitor.
in some examples, ΔV_{cd2_max} satisfies

$$Δ {V}_{cd 2 \_ max} = \frac{3 \sqrt{3} - 2}{12} \frac{I {T}_{c}}{{C}_{d 1}} .$$

Step 7: the capacitance value C_{d1} is traversed from 0 to Cₘₐₓ, the step length of the traversal is M₁, the above-mentioned steps 1-6 are repeated to obtain the corresponding ΔV_{cd1/cd3_max} of different capacitance values, and when the ΔV_{cd1/cd3_max} is less than or equal to ΔVₗᵢₘᵢₜ for the first time, a corresponding capacitance value is output, that is, a minimum DC-bus capacitance value satisfies the requirement of system capacitor voltage fluctuation. In some examples, Cₘₐₓ is 0.001 mF to 100 mF, and the step length M₁ is 0.0001 mF to 5 mF.

In some examples, the maximum voltage fluctuation of the middle DC-bus capacitor is less than the maximum voltage fluctuation of the upper and lower DC-bus capacitors, and the maximum voltage fluctuation of the upper and lower DC-bus capacitors as the main reference for the DC-bus capacitance minimization.

The method provided by the present invention can be applied to a wide output current frequency 1-1000 Hz condition and a wide carrier frequency 500-10000 Hz condition.

Based on the effective suppression of DC-bus capacitor voltage fluctuation after common mode voltage injection, the present invention constructs an accurate correlation model of DC-bus capacitor voltage fluctuation and DC-bus capacitance value, and further proposes a design method for DC-bus capacitance minimization of HCC. By substituting the given system parameters into the proposed design method, the minimum DC-bus capacitance parameters of the HCC that meet the requirements of system voltage fluctuation can be obtained quickly and accurately, which reduces the cost, volume, and weight of the bus capacitor. The present invention not only reduces the design complexity and cost of the high-power HCC system, but also improves the power density and reliability of the converter.

The following is explained by specific examples.

### Example 1

the proposed method for DC-bus capacitance minimization is used to design the minimum DC-bus capacitor of a specific three-phase HCC system, the specific parameters of the HCC system are as follows:
the DC power supply V_{dc} is used to provide DC power supply voltage, and the voltage is 3.3 kV;
the modulation ratio of HCC system is 1, the reference wave frequency is 5 Hz, and the carrier frequency is 4 kHz;
the three-phase load is composed of three series resistors and inductors, the resistance of the load RL resistor is 8Ω, the inductance is 1 mH, and the system power factor is about 1;
the capacitor voltage fluctuation limit ΔVₗᵢₘᵢₜ of the HCC system is ±10% of the rated operating value of the capacitor voltage of 1100 V, which is 220 V;
the design method for DC-bus capacitance minimization of HCC in this example is shown in FIG. 1, the specific steps are as follows:
(1) the DC-bus voltage is 3.3 kV, the reference wave frequency is 5 Hz, the carrier frequency is 4 kHz, the modulation ratio is 1, the power factor is 1 and the system capacitor voltage fluctuation limit is 10% are obtained when the HCC is operating.
(2) the reference wave V′_{ref_x} is obtained according to formula (1),

$${V}_{ref\_x}^{′} = {V}_{ref\_x} + {V}_{com} = \{ \begin{matrix}{V}_{ref\_a} + {V}_{com} = 0.5 sin ( 10 π t ) + 0.5 + 0.125 sin ( 30 π t ) \\ {V}_{ref\_b} + {V}_{com} = 0.5 sin ( 10 π t - \frac{2 π}{3} ) + 0.5 + 0.125 sin ( 30 π t ) \\ {V}_{ref\_c} + {V}_{com} = 0.5 sin ( 10 π t - \frac{4 π}{3} ) + 0.5 + 0.125 sin ( 30 π t )\end{matrix}$$

(3) the reference wave V′_{ref_x} is substituted into formula (2) to obtain a switch duty ratio D_{Nx} of HCC,

$${D}_{Nx} = f ( {V}_{ref\_x}^{′} ) = \{ \begin{matrix}2 {V}_{ref\_x}^{′} & 0 \leq {V}_{ref\_x}^{′} \leq 1 / 3 \\ 2 / 3 & 1 / 3 \leq {V}_{ref\_x}^{′} \leq 2 / 3 \\ 2 ( 1 - {V}_{ref\_x}^{′} ) & 2 / 3 \leq {V}_{ref\_x}^{′} \leq 1\end{matrix}$$

(4) the switch duty ratio D_{Nx} and the load current iₒₓ are substituted into formula (3) to obtain the total neutral point current of the system,

$${i}_{N} = {D}_{Na} {i}_{oa} + {D}_{Nb} {i}_{ob} + {D}_{Nc} {i}_{oc}$$

where the load current satisfies

$$\{ \begin{matrix}{i}_{oa} = I sin ( 10 π t - φ ) \\ {i}_{ob} = I sin ( 10 π t - φ - \frac{2 π}{3} ) \\ {i}_{ob} = I sin ( 10 π t - φ - \frac{4 π}{3} )\end{matrix} ,$$

the maximum load current is

$$I = \frac{1}{2} \frac{{m}_{a} {V}_{dc}}{Z} = 206 A .$$

(5) the total neutral point current i_{N} of the system is substituted into formula (4) to obtain the fundamental component of the upper and lower DC-bus capacitors voltages V_{cap},

$${V}_{cap} = \frac{{\int }_{0}^{t} {i}_{N} dt}{{C}_{d 1}}$$

(6) V cap is substituted into formula (5) to obtain the maximum voltage fluctuation of upper and lower DC-bus capacitors,

$$Δ {V}_{cd 1 / cd 3 \_ max} = Δ {V}_{cd 1 / cd 3 \_ f \_ max} + Δ {V}_{cd 1 / cd 3 \_ h \_ max} = \frac{max ( {V}_{cap} ) - min ( {V}_{cap} )}{2} + 3 Δ {V}_{cd 2 \_ max}$$

where ΔV_{cd1/cd3_f_max} is the fundamental component of the maximum voltage fluctuation of the upper and lower DC-bus capacitors; ΔV_{cd1/cd3_h_max} is the harmonic component of the maximum voltage fluctuation of the upper and lower DC-bus capacitors; ΔV_{cd2_max} is the maximum voltage fluctuation of the middle DC-bus capacitor, which satisfies

$$Δ {V}_{cd 2 \_ max} = \frac{3 \sqrt{3} - 2}{12} \frac{I {T}_{c}}{{C}_{d 1}} = \frac{3 \sqrt{3} - 2}{12} \frac{0.052}{{C}_{d 1}} .$$

(7) the capacitance value is traversed from 0 to 10 mF, the step length of the traversal is 0.01 mF, and the above-mentioned steps 1-6 are repeated to obtain the corresponding ΔV_{cd1/cd3_max} of different capacitance values, it is judged that when the ΔV_{cd1/cd3_max} is less than or equal to 220 V for the first time, the corresponding capacitance value 0.27 mF is output, that is, the minimum DC-bus capacitance value satisfies the requirement of system capacitor voltage fluctuation is 0.27 mF.

Through the above method, the minimum DC-bus capacitance value of HCC system is 0.27 mF when the capacitor voltage fluctuation limit ΔVₗᵢₘᵢₜ is +10% of the rated operating value of the capacitor voltage.

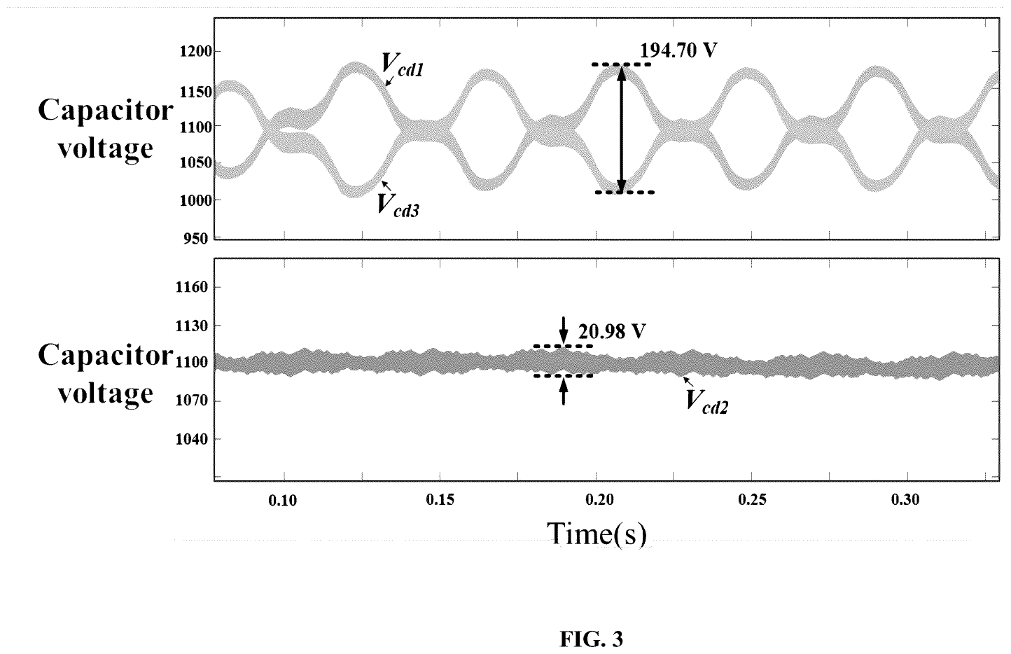

FIG. 3 is a simulation waveform diagram of each DC-bus capacitor voltage of the HCC system under the 0.27 mF bus capacitor parameters obtained by using the design method for DC-bus capacitance minimization of the present invention.

From the analysis of FIG. 3, it can be seen that when the minimum DC-bus capacitance of 0.27 mF obtained by the design method for DC-bus capacitance minimization provided by the present invention is applied, the peak value of the middle DC capacitor voltage is 20.98 V, which is less than the voltage fluctuation of the upper and lower DC-bus capacitors. The peak value of the voltage fluctuation of the upper and lower DC-bus capacitors is 194.70 V, and the fluctuation is ±8.9% of the rated operating value of the capacitor voltage. In the actual selection of capacitance value, it is often considered to leave a certain margin, so as to avoid the fluctuation of capacitance voltage in extreme cases beyond the allowable range of the system. The difference between the actual HCC capacitor voltage fluctuation and the maximum allowable fluctuation under the minimum capacitance value obtained by the invention is within 2%, and a more accurate calculation of the minimum DC-bus capacitance value is realized.

In summary, the design method for DC-bus capacitance minimization of HCC provided by the invention directly calculates the minimum DC-bus capacitance parameters satisfying the voltage fluctuation requirement of the HCC capacitance through the constructed mathematical model, which significantly reduces the design complexity and volume of the HCC system. The present invention is applicable to wide-frequency conditions, effectively solves the problem of selecting the minimum HCC DC-bus capacitance under common conditions, and has the value of popularization and application in the fields of medium and high voltage power conversion and motor drive.

Finally, it should be noted that the above examples are merely used for describing the technical solutions of the present invention, rather than limiting the same. Although the present invention has been described in detail with reference to the preferred examples, those of ordinary skill in the art should understand that the technical solutions of the present invention may still be modified or equivalently replaced. However, these modifications or substitutions should not make the modified technical solutions deviate from the spirit and scope of the technical solutions of the present invention.

What is claimed is:

1. A method for DC-bus capacitance minimization of hybrid clamped converter, including the following steps:
step 1: obtaining a DC-bus voltage V_{dc}, a reference wave frequency f_{ac}, a carrier frequency f_{c}, a modulation ratio mₐ, a power factor cos φ, a load impedance Z, and a system capacitor voltage fluctuation limit ΔVₗᵢₘᵢₜ when the HCC is operating;
step 2: determining a reference wave V′_{ref_x}:
$${V}_{ref \_ x}^{′} = {V}_{ref \_ x} + {V}_{com} = \{ \begin{matrix}{V}_{ref \_ a} + {V}_{com} = \frac{{m}_{a}}{2} sin ( 2 π {f}_{ac} t ) + 0.5 + {V}_{com} \\ {V}_{ref \_ b} + {V}_{com} = \frac{{m}_{a}}{2} sin ( 2 π {f}_{ac} t - \frac{2 π}{3} ) + 0.5 + {V}_{com} \\ {V}_{ref \_ c} + {V}_{com} = \frac{{m}_{a}}{2} sin ( 2 π {f}_{ac} t - \frac{2 π}{3} ) + 0.5 + {V}_{com}\end{matrix}$$
where, V_{ref_x} takes V_{ref_a}, V_{ref_b}, V_{ref_c}, V_{ref_a}, V_{ref_b}, and V_{ref_c} denote a reference wave of a-phase, b-phase, and c-phase, respectively; V_{com} denotes a common-mode voltage;
step 3: determining a switch duty ratio D_{Nx} of HCC according to the reference wave V′_{ref_x}:
$${D}_{Nx} = f ( {V}_{ref \_ x}^{′} ) = \{ \begin{matrix}2 {V}_{ref \_ x}^{′} & 0 \leq {V}_{ref \_ x}^{′} \leq 1 / 3 \\ 2 / 3 & 1 / 3 \leq {V}_{ref \_ x}^{′} \leq 2 / 3 \\ 2 ( 1 - {V}_{ref \_ x}^{′} ) & 2 / 3 \leq {V}_{ref \_ x}^{′} \leq 1\end{matrix}$$
step 4: determining a total neutral point current in of the system according to the switch duty ratio D_{Nx} and a load current iₒₓ:
$${i}_{N} = {D}_{Na} {i}_{oa} + {D}_{Nb} {i}_{ob} + {D}_{Nc} {i}_{oc}$$
where D_{Nx} denotes a switch duty ratio of a-phase, b-phase or c-phase; D_{Na} denotes the switch duty ratio of a-phase; D_{Nb} denotes the switch duty ratio of b-phase; D_{Nc} denotes the switch duty ratio of the c-phase; iₒₓ denotes the load current of a-phase, b-phase or c-phase; iₒₐ denotes the load current of a-phase; i_{ob} denotes the load current of b-phase; i_{oc} denotes the load current of c-phase;
step 5: determining a fundamental component V_{cap} of the capacitors voltage of the upper and lower DC-bus of the system according to the total neutral point current i_{N} of the system:
$${V}_{cap} = \frac{{\int }_{0}^{t} {i}_{N} dt}{{C}_{d 1}}$$
where C_{d1} denotes a value of the DC-bus capacitance to be determined, the DC-bus capacitors are divided into three DC-bus capacitors: upper, middle, and lower, and the three capacitance values are equal;
step 6: determining a maximum voltage fluctuation ΔV_{cd1/cd3_max} of upper and lower DC-bus capacitors according to V_{cap}:
$$Δ {V}_{cd 1 / cd 3 \_ max} = Δ {V}_{cd 1 / cd 3 \_ f \_ max} + Δ {V}_{cd 1 / cd 3 \_ h \_ max} = \frac{max ( {V}_{cap} ) - min ( {V}_{cap} )}{2} + 3 Δ {V}_{cd 2 \_ max}$$
where ΔV_{cd1/cd3_f_max} is the fundamental component of the maximum voltage fluctuation of the upper and lower DC-bus capacitors; ΔV_{cd1/cd3_h_max} is a harmonic component of the maximum voltage fluctuation of the upper and lower DC-bus capacitors; max(V_{cap}) is a maximum value of the fundamental component of the upper and lower DC-bus capacitors voltage, and min(V_{cap}) is a minimum value of the fundamental component of the upper and lower DC-bus capacitors voltage; ΔV_{cd2_max} is a maximum voltage fluctuation of the middle DC-bus capacitor;
step 7: traversing the capacitance value C_{d1} from 0 to Cₘₐₓ, a step length of the traversal is M₁, repeating the above-mentioned steps 1-6 to obtain the corresponding ΔV_{cd1/cd3_max} of different capacitance values, and when the ΔV_{cd1/cd3_max} is less than or equal to ΔVₗᵢₘᵢₜ for the first time, outputting the corresponding capacitance value, that is, a minimum DC-bus capacitance value satisfying the requirement of system capacitor voltage fluctuation.

2. The method for DC-bus capacitance minimization of hybrid clamped converter according to claim 1, wherein in step 1, the range of ΔVₗᵢₘᵢₜ is 0-100% of the rated operating value of the capacitor voltage, and the rated operating value of the capacitor voltage is ⅓ of the DC-bus voltage.

3. The method for DC-bus capacitance minimization of hybrid clamped converter according to claim 1, wherein in step 2,
$${V}_{com} = 0.25 \frac{{m}_{a}}{2} sin ( 23 {f}_{ac} π t ) .$$

4. The method for DC-bus capacitance minimization of hybrid clamped converter according to claim 1, wherein in step 4, the load current iₒₓ satisfies
$$\{ \begin{matrix}{i}_{oa} = I sin ( 2 π {f}_{ac} t - φ ) \\ {i}_{ob} = I sin ( 2 π {f}_{ac} t - φ - \frac{2 π}{3} ) \\ {i}_{ob} = I sin ( 2 π {f}_{ac} t - φ - \frac{4 π}{3} )\end{matrix} ,$$
where I denotes a maximum load current amplitude,
$$I = \frac{1}{2} \frac{{m}_{a} {V}_{dc}}{Z} .$$

5. The method for DC-bus capacitance minimization of hybrid clamped converter according to claim 1, wherein in step 6,
$$Δ {V}_{cd 2 \_ max} = \frac{3 \sqrt{3} - 2}{12} \frac{I {T}_{c}}{{C}_{d 1}} ,$$
where T_{c} is a reciprocal of the carrier frequency f_{c}.

6. The method for DC-bus capacitance minimization of hybrid clamped converter according to claim 1, the maximum voltage fluctuation of the upper and lower DC-bus capacitors as the main reference for the DC-bus capacitance minimization.

7. The method for DC-bus capacitance minimization of hybrid clamped converter according to claim 1, wherein in step 7, Cₘₐₓ is 0.001 mF to 100 mF, and the step length M₁ is 0.0001 mF to 5 mF.

8. The method for DC-bus capacitance minimization of hybrid clamped converter according to claim 1, the method is applicable to a wide output voltage current frequency 1-1000 Hz condition and a wide carrier frequency 500-10000 Hz condition.
